(19) United States
(12) Patent Application Publication
(10) Pub. No.: US 2022/0207377 A1
(43) Pub. Date: Jun. 30, 2022

(54) METHODS AND APPARATUSES FOR TRAINING NEURAL NETWORKS AND DETECTING CORRELATED OBJECTS

(71) Applicant: SENSETIME INTERNATIONAL PTE. LTD., Singapore (SG)

(72) Inventors: Xuesen ZHANG, Singapore (SG); Chunya LIU, Singapore (SG); Bairun WANG, Singapore (SG); Jinghuan CHEN, Singapore (SG)

(21) Appl. No.: 17/342,166

(22) Filed: Jun. 8, 2021

Related U.S. Application Data
(63) Continuation of application No. PCT/IB2021/053493, filed on Apr. 28, 2021.

(30) Foreign Application Priority Data
Dec. 31, 2020 (SG) 10202013245S

(51) Int. Cl. G06N 3/08; G06K 9/62

(52) U.S. Cl. CPC G06N 3/084; G06K 9/623; G06K 9/6256; G06K 9/6239

(57) ABSTRACT

Methods and apparatus for training neural networks and detecting correlated objects are provided. In one aspect, a method of training a neural network includes: detecting a first-class object and second-class objects in an image; generating at least one candidate object group based on the detected first-class object and second-class objects, each candidate object group including at least one first-class object and at least two second-class objects; for each candidate object group, determining a matching degree between the first-class object and each second-class object in the candidate object group based on a neural network; determining a group correlation loss of the candidate object group based on the determined matching degree, the group correlation loss being positively correlated with a matching degree between the first-class object and a non-correlated second-class object; and adjusting network parameters of the neural network based on the group correlation loss.

### CROSS REFERENCE TO RELATED APPLICATIONS

This application is a continuation of PCT International Application No. PCT/IB2021/053493, filed on Apr. 28, 2021, which claims priority to Singapore Patent Application No. 10202013245S filed on Dec. 31, 2020. The entire contents of the above referenced applications are incorporated herein by reference for all purposes.

### TECHNICAL FIELD

The present disclosure relates to the field of computer vision technology, and in particular to methods and apparatus for training neural networks and detecting correlated objects.

### BACKGROUND

In intelligent scenario detection, detection and recognition of an object is an important research topic. Multi-dimensional object analysis may obtain a rich variety of object information, which facilitates research of a state and a change trend of an object. In a specific scenario of object detection and recognition, a correlation between objects in an image may be analyzed to automatically extract a potential relationship between the objects so as to obtain more correlation information in addition to characteristics of the objects.

In a multi-object scenario, especially in a scenario in which some of a plurality of objects in an image are blocked or overlap, since the analysis of correlation between objects is relatively difficult, the determination of correlated objects cannot easily have an accurate result merely based on prior knowledge such as a position relationship between objects, for example, missed detection, false detection, or other cases may occur. Take intelligent detection in a multi-player game as an example, it is required to correlate body parts of different persons in a video, such as hands and a face, with a human body of the corresponding person to recognize actions of different persons. However, blocking or overlapping occurred among a plurality of human bodies will increase the difficulty of detecting a correlation between body parts and a human body.

### SUMMARY

The present disclosure provides methods and apparatus for training neural networks detecting correlated objects.

According to a first aspect of an example of the present disclosure, there is provided a method of training a neural network. The method includes: detecting a first-class object and a second-class object in an image; generating at least one candidate object group based on the detected first-class object and the detected second-class object, where the candidate object group includes at least one first-class object and at least two second-class objects; determining a matching degree between the first-class object and each second-class object in the same candidate object group based on a neural network; determining a group correlation loss of the candidate object group based on the matching degree between the first-class object and each second-class object in the same candidate object group, where the group correlation loss is positively correlated with a matching degree between the first-class object and a second-class object which is non-correlated with the first-class object; and adjusting network parameters of the neural network based on the group correlation loss.

In some examples, the group correlation loss is also negatively correlated with a matching degree between the first-class object and a second-class object correlated with the first-class object in the candidate object group.

In some examples, the method further includes: determining that training of the neural network is completed when the group correlation loss is less than a preset loss value.

In some examples, detecting the first-class object and the second-class object in the image includes: extracting a feature map of the image; and determining the first-class object and the second-class object in the image based on the feature map. Determining the matching degree between the first-class object and each second-class object in the same candidate object group based on the neural network includes: determining a first feature of the first-class object based on the feature map; obtaining a second feature set corresponding to the first feature by determining a second feature of each second-class object in the candidate object group based on the feature map; obtaining an assemble feature set by assembling each second feature in the second feature set with the first feature respectively; and determining the matching degree between the second-class object and the first-class object corresponding to an assemble feature in the assemble feature set based on the neural network.

In some examples, each second-class object and the first-class object in the candidate object group satisfy a preset relative position relationship; or there is an overlapping region between a detection box of each second-class object in the candidate object group and a detection box of the first-class object in the candidate object group.

In some examples, the first-class object includes a first human body part object, and the second-class object includes a human body object; or the first-class object includes a human body object, and the second-class object includes a first human body part object.

In some examples, the first human body part object includes a human face object or a human hand object.

In some examples, the method further includes: detecting a third-class object in the image; generating the at least one candidate object group based on the detected first-class object and the detected second-class object includes: generating at least one candidate object group based on the detected first-class object, the detected second-class object and the detected third-class object, where each candidate object group further includes at least two third-class objects; the method further includes: determining a matching degree between the first-class object and each third-class object in the same candidate object group based on the neural network; the group correlation loss is also positively correlated with a matching degree between the first-class object and a third-class object non-correlated with the first-class object.

In some examples, the third-class object includes a second human body part object.

According to a second aspect of an example of the present disclosure, there is provided a method of detecting correlated objects. The method includes: detecting a first-class object and a second-class object in an image; generating at least one object group based on the detected first-class object and the detected second-class object, where the object group includes one first-class object and at least two second-class objects; determining a matching degree between the first-class object and each second-class object in the same object group; and determining a second-class object correlated with the first-class object based on the matching degree between the first-class object and each second-class object in the same object group.

In some examples, generating the at least one object group based on the detected first-class object and the detected second-class object includes: performing a combination operation for the detected first-class object; the combination operation includes: combining the first-class object and any at least two detected second-class objects into one object group; or combining the first-class object and each detected second-class objects into one object group.

In some examples, generating at least one object group based on the detected first-class object and the detected second-class object includes: determining at least two second-class objects satisfying a preset relative position relationship with the first-class object as candidate correlated objects of the first-class object based on position information of the detected first-class object and the detected second-class object; and combining the first-class object and each candidate correlated object of the first-class object into one object group.

In some examples, the first-class object includes a first human body part object, and the second-class object includes a human body object; or the first-class object includes a human body object, and the second-class object includes a first human body part object.

In some examples, the first human body part object includes a human face object or a human hand object.

In some examples, the method further includes: detecting a third-class object in an image; generating at least one object group based on the detected first-class object and the detected second-class object includes: generating at least one object group based on the detected first-class object, the detected second-class object and the detected third-class object, where the object group further includes at least two third-class objects; the method further includes: determining a matching degree between the first-class object and each third-class object in the same object group; and determining a third-class object correlated with the first-class object based on the matching degree between the first-class object and each third-class object in the same object group.

In some examples, the third-class object includes a second human body part object.

In some examples, determining the matching degree between the first-class object and each second-class object in the same object group includes: determining the matching degree between the first-class object and each second-class object in the same object group based on a pre-trained neural network, where the neutral network is obtained through training by any one method according to the first aspect.

According to a third aspect of an example of the present disclosure, there is provided an apparatus for training a neural network. The apparatus includes: an object detecting module, configured to detect a first-class object and a second-class object in an image; a candidate object group generating module, configured to generate at least one candidate object group based on the detected first-class object and the detected second-class object, where the candidate object group includes at least one first-class objects and at least two second-class objects; a matching degree determining module, configured to determine a matching degree between the first-class object and each second-class object in the same candidate object group based on the neural network; a group correlation loss determining module, configured to determine a group correlation loss of the candidate object group based on the matching degree between the first-class object and each second-class object in the same candidate object group, where the group correlation loss is positively correlated with the matching degree between the first-class object and a second-class object non-correlated with the first-class object; and a network parameter adjusting module, configured to adjust network parameters of the neural network based on the group correlation loss.

According to a fourth aspect of an example of the present disclosure, there is provided an apparatus for detecting correlated objects. The apparatus includes: a detecting module, configured to detect a first-class object and a second-class object in an image; an object group generating module, configured to generate at least one object group based on the detected first-class object and the detected second-class object, where the object group includes one first-class object and at least two second-class objects; a determining module, configured to determine a matching degree between the first-class object and each second-class object in the same object group; and a correlated object determining module, configured to determine a second-class object correlated with the first-class object based on the matching degree between the first-class object and each second-class object in the same object group.

According to a fifth aspect of an example of the present disclosure, there is provided a computer device, including a memory, a processor and computer programs that are stored on the memory and operable on the processor. The programs are executed by the processor to implement any one method of training a neural network according to the first aspect or any one method of detecting correlated objects according to the second aspect.

According to a sixth aspect of an example of the present disclosure, there is provided a computer readable storage medium storing computer programs thereon. The programs are executed by the processor to implement any one method of training a neural network according to the first aspect or any one method of detecting correlated objects according to the second aspect.

According to a seventh aspect of an example of the present disclosure, there is provided a computer program product, including computer programs. The programs are executed by the processor to implement any one method of training a neural network according to the first aspect or any one method of detecting correlated objects according to the second aspect.

In an example of the present disclosure, by detecting a first-class object and a second-class object in the image, a candidate object group is generated based on the detected at least one first-class object and at least two second-class objects. Matching degrees between the first-class object and each second-class object are determined based on a neural network, a group correlation loss corresponding to the candidate object group is obtained based on the determined matching degrees, and network parameters of the neural network are adjusted based on the group correlation loss to complete training of the neural network. In this training manner, a loss function (the group correlation loss) is obtained based on the matching degrees of a plurality of matching pairs formed by the first-class object and second-class objects in the candidate object group, and then, the network parameters of the neural network are adjusted based on the group correlation loss corresponding to the candidate object group. This training manner may realize global optimization of the neutral network by using a plurality of matching pairs. By minimizing the loss function, the matching degree of a false matching pair is suppressed, and a distance between the objects of a false matching pair is widened; further, the matching degree of a correct matching pair is promoted, and a distance between the objects of a correct matching pair is shortened. Therefore, the neural network obtained through training in this manner is enabled to detect and determine the correct matching pairs between the first-class objects and the second-class objects in the image more accurately, and determine the correlation between the first-class object and the second-class object more accurately.

It is to be understood that the above general descriptions and the below detailed descriptions are merely exemplary and explanatory, and are not intended to limit the present disclosure.

### BRIEF DESCRIPTION OF THE DRAWINGS

Accompanying drawings, which are incorporated in and constitute a part of the specification, illustrate examples consistent with the present disclosure and serve to explain the principles of the present disclosure together with the specification.

FIG. 1 is a flowchart illustrating a method of training a neural network according to an example of the present disclosure.

FIG. 2 is a schematic diagram illustrating a detected image according to an example of the present disclosure.

FIG. 3 is a schematic diagram illustrating a neural network framework according to an example of the present disclosure.

FIG. 4 is a flowchart illustrating a method of determining a matching degree according to an example of the present disclosure.

FIG. 5 illustrates a method of detecting correlated objects according to an example of the present disclosure.

FIG. 6 illustrates an apparatus for training a neural network according to an example of the present disclosure.

FIG. 7 illustrates another apparatus for training a neutral network according to an example of the present disclosure.

FIG. 8 illustrates an apparatus for detecting correlated objects according to an example of the present disclosure.

FIG. 9 is a structural schematic diagram illustrating a computer device according to an example of the present disclosure.

### DETAILED DESCRIPTION OF THE EMBODIMENTS

Examples will be described in detail herein, with the illustrations thereof represented in the drawings. When the following descriptions involve the drawings, like numerals in different drawings refer to like or similar elements unless otherwise indicated. Specific implementations described in the following examples do not represent all solutions consistent with the present disclosure. Rather, they are merely examples of apparatuses and methods consistent with some aspects of the present disclosure as detailed in the appended claims.

Terms used in the present disclosure are only for the purpose of describing particular examples, and are not intended to limit the present disclosure. Terms determined by “a”, “the” and “said” in their singular forms in the present disclosure and the appended claims are also intended to include plurality, unless clearly indicated otherwise in the context. It should also be understood that the term “and/or” as used herein refers to and includes any and all possible combinations of one or more of the correlated listed items.

It is to be understood that, although terms “first,” “second,” “third,” and the like may be used in the present disclosure to describe various information, such information should not be limited to these terms. These terms are only used to distinguish one category of information from another. For example, without departing from the scope of the present disclosure, first information may also be referred to as second information; and similarly, second information may also be referred to as first information. Depending on the context, the word “if” as used herein may be interpreted as “when” or “upon” or “in response to determining”.

To correlate parts of a body with the body is an important step in intelligent video analysis. For example, in a scenario in which intelligent monitoring is performed for a multi-player chess and card game process, a system needs to correlate different human hands with corresponding human bodies in a video to determine actions of different persons, so as to realize intelligent monitoring of different persons in the multi-player chess and card game process.

The present disclosure provides a method of training a neural network. The training method may better adjust network parameters of the neural network, so that the neural network obtained through the training may detect matching degrees between human body parts and a human body more accurately, thereby determining a correlation between the human body parts and the human body in an image. In the process of training the neural network, at least one candidate object group may be generated based on at least one first-class object and second-class objects detected in the image, a matching degree between the first-class object and each second-class object in the same candidate object group may be determined based on the neural network, and a group correlation loss (also referred to as group loss) corresponding to the candidate object group may be obtained based on the determined matching degrees so as to adjust network parameters of the neural network based on the group correlation loss.

To illustrate the method of training a neural network according to the present disclosure more clearly, an implementation process of the technical solution of the present disclosure will be further described in detail below in combination with accompanying drawings and specific examples.

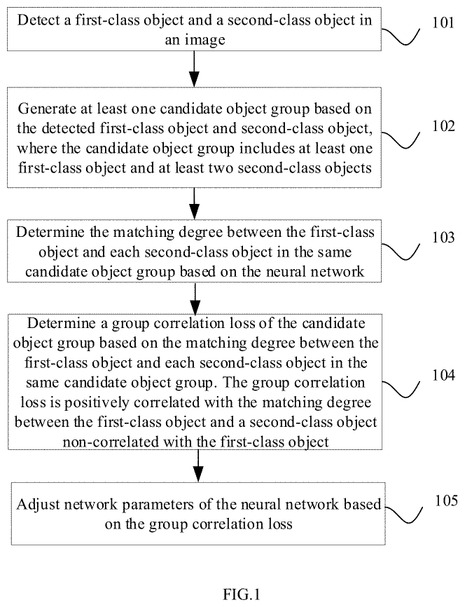

FIG. 1 is a flowchart illustrating a method of training a neural network according to an example of the present disclosure. As shown in FIG. 1, the flow includes the following blocks.

At block 101, at least one first-class object and second-class objects in an image are detected.

The detected image may be an image containing various classes of objects. The object classes are pre-defined, for example, including two classes of persons and articles, classes divided based on attributes such as gender and age of a person, or classes divided based on characteristics such as color and function of articles, and so on.

In some examples, the objects in the image may include a human body part object and a human body object. That is, the above first-class object and second-class object may be the human body part object or the human body object. The human body part object includes parts such as hands, a face and feet of a human body. Illustratively, under monitoring for the multi-player chess and card game process by an intelligent monitoring device, an image collected by the device may be taken as an image to be detected at this block.

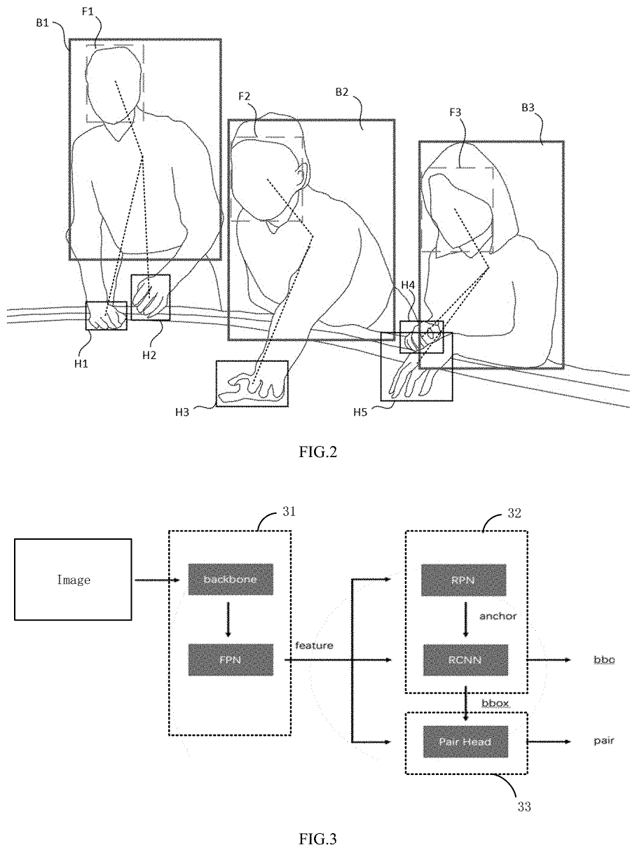

FIG. 2 illustrates an image collected by an intelligent monitoring device in a multi-player game scenario, and the image may be taken as the image to be detected in an example of the present disclosure. The collected image includes a plurality of human body objects participating in the game, including: human bodies B1, B2 and B3, and corresponding hand objects (body part objects), including: human hands H1 and H2 corresponding to the human body B1, a human hand H3 corresponding to the human body B2, and human hands H4 and H5 corresponding to the human body B3. As illustrated in FIG. 2, the human body object may be indicated by a human body detection box, and the hand object may be indicated by a hand detection box.

In an example of the present disclosure, the first-class object in the image is different from the second-class object, and there is a certain correlation between the first-class object and the second-class object. When the first-class object includes a human body part object, the second-class object may include a human body part object with a type different from that of the human body part object included in the first-class object, or the second-class object may include a human body object. In an example, when the second-class object includes a human body part object, the first-class object may include a human body part object with a type different from that of the human body part object included in the second-class object, or may include a human body object. The type of the human body part object corresponds to a body part indicated by the type. For example, a human face object, a human hand object and a human elbow object correspond to a human face, a human hand and a human elbow respectively, and their types are different from each other.

In some examples, the first-class object includes a first human body part object, and the second-class object includes a human body object; or the first-class object includes a human body object, and the second-class object includes a first human body part object. The first human body part object includes a human face object or a human hand object.

Illustratively, the human hand object is taken as the first-class object and the human body object is taken as the second-class object, and the human hand object and the human body object in the image may be detected at this block. As shown in FIG. 2, the first-class objects including human hands H1, H2, H3, H4 and H5 and the second-class objects including human bodies B1, B2 and B3 may be detected from FIG. 2 at this block.

It may be understood that the image detected at this block may be obtained in several different manners to realize training of the neural network, which is not limited in the examples of the present disclosure. Illustratively, the intelligent monitoring device may collect images in different scenarios. For example, the intelligent monitoring device may collect images during a multi-player chess and card game. Illustratively, images including a human body part object and the human body object may be screened out from different image databases.

It is to be noted that the first-class object and the second-class object in the image may be detected in different manners at this block, which is not limited in this example. Illustratively, the first-class object in the image may be firstly obtained through one time of detection, and the second-class object in the image may be then obtained through another time of detection, so as to finally obtain the first-class object and the second-class object in the image. In an example, the first-class object and the second-class object in the image may be obtained through one time of detection at the same time.

In some possible implementations, a detection network capable of detecting the first-class object and the second-class object in the image at the same time may be obtained through pre-training, so that the detection network obtained through pre-training may be utilized to obtain the first-class object and the second-class object from the image in one time of detection. For example, a face-body joint detection neural network may be obtained through pre-training, and the human face object and the human body object may be detected from the image at the same time by use of the face-body joint detection neural network obtained through pre-training in this example.

At block 102, at least one candidate object group is generated based on the detected first-class objects and second-class objects, where the candidate object group includes at least one first-class object and at least two second-class objects.

At this block, when the first-class objects and the second-class objects in the image are detected, one candidate object group may be generated based on one detected first-class object and at least two detected second-class objects; or one candidate object group may be generated based on at least two first-class objects and at least two second-class objects. Since the number of the detected first-class objects in the image may be multiple, the number of the candidate object groups generated based on the first-class objects may also be multiple.

Description are still made with the first-class objects including human hands H1, H2, H3, H4 and H5 and the second-class objects including human bodies B1, B2 and B3 detected in FIG. 2 as an example. Corresponding candidate object groups may be generated based on the first-class objects and the second-class objects detected in FIG. 2 at this block. Illustratively, a candidate object group may be obtained by combining the human hand H1, the human body B1, the human body B2 and the human body B3; or another candidate object group may be obtained by combining the human hand H1, the human hand H2, the human body B1, the human body B2 and the human body B3. It may be understood that more different candidate object groups may also be generated in different combination manners, which will not be enumerated herein.

In some examples, each second-class object and the first-class object in the candidate object group satisfy a preset relative position relationship; or there is an overlapping region between a detection box of each second-class object and a detection box of the first-class object in the candidate object group.

In the above example, the relative position relationship may be preset. For any one detected first-class object, second-class objects satisfying the relative position relationship with the first-class object are added into the candidate object group to which the first-class object belongs. In this case, it may be ensured that the first-class object and the second-class objects in the same candidate object group satisfy the preset relative position relationship. The preset relative position relationship may include at least one of the following: a position distance between the first-class object and the second-class object is less than a preset threshold, and there is an overlapping region between the detecting boxes of the first-class object and the second-class object. In this case, the distances between the first-class object and each second-class object in the same candidate object group are less than the preset threshold, and/or there is an overlapping region between the detection boxes of the first-class object and the second-class object in the same candidate object group.

In the example, the relative position ship being satisfied may be pre-configured, thus the first-class object and each second-class object in the same candidate object group become objects having a correlation possibility to each other, and then second-class objects correlated with the first-class object correctly are further determined from the candidate object group. In this manner, those objects having a correlation possibility in the first-class objects and the second-class objects detected in the image are preliminarily classified into the same candidate object group, so that second-class objects correctly correlated the first-class object are further determined from the candidate object group, increasing the calculation accuracy of the matching degrees between the first-class object and each second-class object.

With FIG. 2 as an example, the relative position relationship may be preset as follows: the detection boxes are overlapped. Therefore, in the same candidate object group, the detection box of the first-class object, i.e., the human hand H5 has an overlapping region with the detection boxes of the second-class objects, i.e., the human bodies B2 and B3 respectively.

At block 103, the matching degrees between the first-class object and each second-class object in the same candidate object group are determined based on the neural network.

The neural network for detecting the matching degrees between the first-class object and each second-class object may be preset at this block. For example, a neural network to be utilized at this block may be obtained by pre-training a known neural network available for inter-object correlation detection using training samples. The matching degrees between the first-class object and each second-class object in the same candidate object group may be determined based on the preset neural network at this block. The matching degree is used to represent a correlation degree between the detected first-class object and second-class object. The matching degree may be specifically represented in several forms, which is not limited in the example of the present disclosure. Illustratively, the matching degree may be represented by numerical value, percentage, grade, and the like.

Take FIG. 2 as an example, a candidate object group G1 includes: a first-class object, i.e., the human hand H5, and second-class objects, i.e., the human bodies B2 and B3. The matching degree M1 between the human hand H5 and the human body B2 and the matching degree M2 between the human hand H5 and the human body B3 in the candidate object group G1 may be determined based on the preset neural network at this block.

At block 104, a group correlation loss of the candidate object group is determined based on the matching degrees between the first-class object and each second-class object in the same candidate object group. The group correlation loss is positively correlated with the matching degree between the first-class object and a non-correlated second-class object.

In this example, the correlation between the first-class object and the second-class object may be pre-labeled. The first-class object being correlated with the second-class object represents that they have a specific similar relationship, a same attribution relationship, and the like. The correlation between the first-class object and the second-class object in the detected image may be labeled manually so as to obtain labeling information. Therefore, the second-class object correlated with the first-class object and the second-class object non-correlated with the first-class object in the same candidate object group may be distinguished.

In combination with the above FIG. 2, two corresponding matching degrees, i.e., the matching degree M1 and the matching degree M2, are obtained from the candidate object group G1. A group correlation loss (Group loss1) corresponding to the candidate object group G1 may be determined based on the two obtained matching degrees at this block. Further, the first-class object, i.e., the human hand H5 is non-correlated with the second-class object, i.e., the human body B2. Correspondingly, the Group loss1 is positively correlated with the matching degree M1.

The group correlation loss is positively correlated with the matching degree between the first-class object and the second-class object non-correlated with the first-class object. Therefore, by minimizing the group correlation loss, the matching degree between the first-class object and the second-class object non-correlated with the first-class object is suppressed, and the distance between the first-class object and the second-class object non-correlated with the first-class object is widened, so that the trained neural network is capable of distinguishing the first-class object from the second-class object better.

In some examples, the group correlation loss is also negatively correlated with the matching degree between the first-class object and the second-class object correlated with the first-class object in the candidate object group. For example, since the first-class object, i.e., the human hand H5 is correlated with the second-class object, i.e., the human body B3, the group correlation loss 1 is negatively correlated with the matching degree M2.

The group correlation loss is negatively correlated with the matching degree between the first-class object and the second-class object correlated with the first-class object. Therefore, by minimizing the group correlation loss, the matching degree between the first-class object and the second-class object correlated with the first-class object is promoted, and the distance between the first-class object and the second-class object correlated with the first-class object is shortened, so that the trained neural network is capable of determining the second-class object correlated with the first-class object better. As a result, global optimization of the neural network is realized and the accuracy of the calculation result of the matching degree between the first-class object and the second-class object is improved.

With the following specific example, descriptions are made to how to set a loss function (in order to obtain the group correlation loss), so as to enable the group correlation loss to be positively correlated with the matching degree between the first-class object and the second-class object non-correlated with the first-class object, and to be negatively correlated with the matching degree between the first-class object and the second-class object correlated with the first-class object.

In combination with the image shown in FIG. 2, the preset loss function is described exemplarily. A candidate object group G2 includes a first-class object, i.e., the human hand H3, and second-class objects, i.e., the human bodies B1, B2 and B3. The human hand H3 is correspondingly correlated with the human body B2 (that is, the human hand H3 and the human body B2 belong to the same person). For example, a matching degree between the human hand H3 and the human body B2 is denoted as S_{P}; a matching degree between the human hand H3 and the human body B1 is denoted as Sₙ₁; a matching degree between the human hand H3 and the human body B3 is denoted as Sₙ₂; the group correlation loss is denoted as L_{Group}. Illustratively, the loss function may be preset as follows:

$${L}_{Group} = - log ( exp ( {s}_{p} ) \text{/} ( exp {s}_{p} + exp {s}_{n 1} + exp {s}_{n 2} ) ) .$$

The group correlation loss of the candidate object group is calculated based on the above loss function. The loss function is negatively correlated with the matching degree between the first-class object and the second-class object correlated with the first-class object in the group, and positively correlated with the matching degree between the first-class object and the second-class object non-correlated with the first-class object in the group. In addition, the neural network can be also converged rapidly.

At block 105, network parameters of the neural network are adjusted based on the group correlation loss.

In some examples, the neural network may be trained with a large number of sample images as the images to be detected in this example, until a preset training requirement is satisfied. In a possible implementation, when the group correlation loss is less than a preset loss value, it is determined that the training of the neural network is completed. In such implementation, by minimizing the loss function, the matching degree between the first-class object and the second-class object non-correlated with the first-class object is suppressed, and the distance between the first-class object and the second-class object non-correlated with the first-class object is widened; further, the matching degree between the first-class object and the second-class object correlated with the first-class object is promoted, and the distance between the first-class object and the second-class object correlated with the first-class object is shortened. In another possible implementation, when the number of times of trainings of the neural network reaches a preset threshold number, it is determined that the training of the neural network is completed.

In an example of the present disclosure, the first-class object and the second-class object in the image are detected, the candidate object group is generated based on at least one first-class object and at least two second-class objects, the matching degrees between the first-class object and each second-class object are determined based on the neural network, the group correlation loss corresponding to the candidate object group is obtained based on the determined matching degrees, and the network parameters of the neural network are adjusted based on the group correlation loss, so as to complete training the neural network.

In this training manner, the loss function (the group correlation loss) is obtained based on the matching degrees of a plurality of matching pairs formed by the first-class object and each second-class object in the candidate object group, and then, the network parameters of the neural network are adjusted based on the loss function corresponding to the candidate object group. This manner may realize global optimization of the neutral network by using a plurality of matching pairs. By minimizing the loss function, the matching degree of a false matching pair is suppressed, and the distance between the objects in the false matching pair is widened; the matching degree of a correct matching pair is promoted, and the distance between the objects in a correct matching pair is shortened. Thus, the neural network obtained through training in this manner may detect and determine a correct matching pair among first-class objects and second-class objects in the image more accurately, and determine the correlation between the first-class objects and the second-class objects more accurately.

In a multi-object scenario, especially in a scenario in which blocking or overlapping is present among a plurality of objects in an image, it is greatly difficult to analyze the correlation between the objects. In the related art, if the correlation is determined merely based on prior knowledge such as a position relationship between objects, missed detection, false detection, or other cases may occur, resulting in difficulty in obtaining accurate detection results. The neural network obtained in the training manner according to the example of the present disclosure may use a plurality of first-class objects and second-class objects having a possible correlation in the image as detected objects of a same group being a candidate object group, so as to realize global optimization of correlation detection of a plurality of matching pairs formed by first-class objects and second-class objects in the image on the basis of the candidate object group, and improve the accuracy of the calculation result of the matching degrees between the first-class object and the second-class objects.

FIG. 3 is a schematic diagram illustrating a network architecture of a correlation detection network according to at least one example of the present disclosure. Training of the neural network or detection of the correlation between the first-class object and the second-class object in the image may be realized based on the correlation detection network. As shown in FIG. 3, the correlation detection network may include the followings.

A feature extraction network 31 is configured to obtain a feature map by performing feature extraction for an image. In an example, the feature extraction network 31 may include a backbone network and a feature pyramid network (FPN). The feature map may be extracted by processing the image by the backbone network and the FPN sequentially.

For example, the backbone network may be VGGNet, ResNet, and the like, and the FPN may convert the feature map obtained from the backbone network into a feature map of a multi-layered pyramid structure. The above backbone network is an image feature extraction portion (backbone) of the correlation detection network; the FPN equivalent to a neck portion in the network architecture performs feature enhancement, for example, may enhance shallow-layered features extracted by the backbone network.

An object detection network 32 is configured to determine at least one first-class object and second-class objects in the image based on the feature map extracted from the image.

As shown in FIG. 3, the object detection network 32 may include a region proposal network (RPN) and a region convolutional neural network (RCNN). The RPN may predict an anchor box (anchor) based on the feature map output by the FPN, the RCNN may predict a detection box (bbox) based on the anchor box and the feature map output by the FPN, and the detection box includes the first-class object or the second-class object. The RCNN may output a plurality of detection boxes.

A pair detection network 33 (pair head), i.e., the neural network to be trained in an example of the present disclosure, is configured to determine a first feature corresponding to the first-class object and a second feature corresponding to the second-class object based on the first-class object or the second-class object in the detection boxes output by the RCNN and the feature map output by the FPN.

The above object detection network 32 and pair detection network 33 are both equivalent to a head portion located in the correlation detection network. Such head portion is a detector for outputting a detected result. The detected result in an example of the present disclosure includes a first-class object, a second-class object and a corresponding correlation.

It is to be noted that a specific network structure of the above correlation detection network formed by the feature extraction network 31, the object detection network 32 and the pair detection network 33 is not limited in the example of the present disclosure, and the structure shown in FIG. 3 is only illustrative. For example, the first-class object or the second-class object may be directly determined by the RPN/RCNN, or the like based on the feature map extracted by the backbone network without using the FPN in FIG. 3. For another example, FIG. 3 illustrates a framework for performing detection in two stages, and the detection may also be performed in one stage in an actual implementation.

Based on the network structure of the correlation detection network shown in FIG. 3, a process of training the neural network (the pair detection network 33) using the correlation detection network will be described in detail in the following example.

In an example of the present disclosure, an image may be input into the correlation detection network where the feature extraction network 31 obtains a feature map by performing feature extraction for the image; the object detection network 32 determines a first-class object and a second-class object in the image by determining a detection box corresponding to the first-class object and a detection box corresponding to the second-class object in the image based on the feature map; the pair detection network 33, i.e., the neural network, generates at least one candidate object group based on the determined at least one first-class object and second-class objects, and determines matching degrees between the first-class object and each second-class object in the same candidate object group.

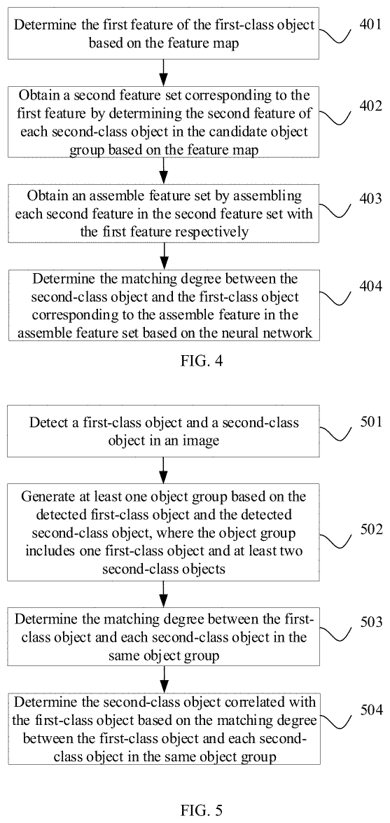

The determination of the matching degrees by the pair detection network 33 is performed at block 103: determining the matching degrees between the first-class object and each second-class object in the same candidate object group based on the neural network. As shown in FIG. 4, the determination of the matching degrees may specifically include the following blocks.

At block 401, a first feature of the first-class object is determined based on the feature map.

The pair detection network 33 may determine the first feature of the first-class object based on the feature map extracted by the feature extraction network 31 in combination with the detection box corresponding to the first-class object output by the object detection network 32.

At block 402, a second feature set corresponding to the first feature is obtained by determining the second feature of each second-class object in the candidate object group based on the feature map.

The pair detection network 33 may determine the second feature corresponding to the second-class object based on the feature map output by the feature extraction network 31 in combination with the detection box corresponding to the second-class object output by the object detection network 32. Based on the same principle, the second feature of each second-class object in the candidate object group may be obtained to form the second feature set corresponding to the candidate object group.

At block 403, an assemble feature set is obtained by assembling each second feature in the second feature set with the first feature respectively.

For each second feature in the second feature set, the pair detection network 33 may perform feature assembling for the second feature and the first feature to obtain an assemble feature of “first feature-second feature”. A specific assembling manner in which feature assembling is performed for the first feature and the second feature is not limited in the example of the present disclosure. In a possible implementation, when the first feature or the second feature is represented by a feature vector, the feature vector corresponding to the first feature and the feature vector corresponding to the second feature may be directly assembled, and the obtained assemble feature vector is taken as an assemble feature of the first-class object and the second-class object.

At block 404, the matching degree between the second-class object and the first-class object corresponding to the assemble feature in the assemble feature set is determined based on the neural network.

The pair detection network 33 may determine a corresponding matching degree between the first-class object and second-class object based on the assemble feature of the first-class object and the second-class object. In a possible implementation, the corresponding matching degree between the first-class object and the second-class object may be calculated by inputting a assemble feature vector into a preset matching degree calculation function. In another possible implementation, a matching degree calculation neural network which satisfies the requirement may be obtained through pre-training with the training sample. Further, when the calculation of the matching degree is needed, the assemble feature vector is input into the matching degree calculation neural network, and then the matching degree between the first-class object and the second-class object is output by the matching degree calculation neural network.

In an example of the present disclosure, the feature map of the image is extracted, and the first-class object and the second-class object in the image are determined based on the extracted feature map. When the matching degree between the first-class object and the second-class object is determined, the assemble feature may be obtained by assembling the first feature and the second feature determined based on the feature map, and then, the matching degree between the first-class object and the second-class object corresponding to the assemble feature may be determined based on the neural network. In this way, the correlation between the first-class object and the second-class object in the image is detected and determined in the form of candidate object group, thereby improving the detection efficiency.

In an example of the present disclosure, after the matching degrees between the first-class object and each second-class object in the same candidate object group are determined, the group correlation loss may be further calculated using the preset loss function based on the determined matching degrees. Then, the network parameters of the pair detection network 33 in the correlation detection network are adjusted based on the group correlation loss to realize training of the neural network. In a possible implementation, the network parameters of one or more of the feature extraction network 31, the object detection network 32 and the pair detection network 33 in the correlation detection network may be adjusted based on the group correlation loss to realize training of the partial or entire correlation detection network.

In some examples, a correlation detection network which satisfies the requirement may be obtained by training the correlation detection network by using a sufficient number of images as the training samples in the above specific process of training the correlation detection network. After the training of the correlation detection network is completed, when it is required to detect the correlation between the first-class object and the second-class object in an image to be detected, the image may be input into the pre-trained correlation detection network, and then the matching degree between the first-class object and the second-class object in the image to be detected is output by the correlation detection network, thereby obtaining a correlation result of the first-class object and the second-class object. The correlation detection network is a network trained by the training method in any example of the present disclosure.

It may be understood that the correlation result output by the correlation detection network may be presented in different forms. Illustratively, with FIG. 2 as an image to be detected, the following correlation result may be output: the human hands H1 and H2—the human body B1; the human hand H3—the human body B2; the human hands H4 and H5—the human body B3. Illustratively, with FIG. 2 as an image to be detected, the following correlation result may be output: the matching degree of the human hand H3—the human body B1 is 0.01; the matching degree of the human hand H3—the human body B2 is 0.99; the matching degree of the human hand H3—the human body B3 is 0.02, and so on. The presentation form of the above correlation results is only exemplary, and does not constitute any limitation to the correlation results.

In some examples, after the first-class object and the second-class object in the image are detected, a third-class object may also be detected from the image. The third-class object is a human body part object different from the first-class object or the second-class object. For example, when the first-class object is a human hand object and the second-class object is a human body object, the third-class object may be a human face object. In this example, the human hand object, the human body object and the human face object may be detected from the image.

In a possible implementation, the third-class object includes a second human body part object. The second human body part object is a human body part different from a first human body part object. For example, the second human body part object includes a human hand object or a human face object. Illustratively, when the first human body part object is a human hand object, the second human body part object may be a human face object or a human foot object.

When the first-class object, the second-class object and the third-class object are detected from the image, at least one candidate object group may be generated based on the detected first-class object, second-class object and third-class object in this example. Each candidate object group includes at least two third-class objects.

For example, one candidate object group may be generated based on one first-class object, at least two second-class objects and at least two third-class objects. In an example, one candidate object group may be generated based on at least two first-class objects, at least two second-class objects and at least two third-class objects.

After the matching degrees between the first-class object and each second-class object in the same candidate object group are determined based on the neural network, such determination further includes determining matching degrees between the first-class object and each third-class object in the same candidate object group based on the neural network in this example.

When the group correlation loss corresponding to the candidate object group is determined, the group correlation loss may be determined based on the matching degrees between the first-class object and each second-class object in the same candidate object group and in combination with the matching degrees between the first-class object and each third-class object in the same candidate object group. The group correlation loss is positively correlated with the matching degree between the first-class object and a third-class object non-correlated with the first-class object. Therefore, by minimizing the loss function, a matching degree between the first-class object and the third-class object non-correlated with the first-class object is suppressed, and a distance between the first-class object and the third-class object non-correlated with the first-class object is widened.

In a possible implementation, the group correlation loss is also negatively correlated with the matching degree between the first-class object and a third-class object correlated with the first-class object. By minimizing the loss function, a matching degree between the first-class object and the third-class object correlated with the first-class object is promoted, and a distance between the first-class object and the third-class object correlated with the first-class object is shortened.

In an example of the present disclosure, the candidate object group is generated based on the detected first-class object, second-class object and third-class object in the image, and the group correlation loss corresponding to the candidate object group is determined based on the matching degrees between the first-class object and each of the second-class object and the third-class object to adjust the network parameters of the neural network. The neural network trained in this way may detect the matching degrees between the first-class object and each of the second-class object and the third-class object at the same time, so that the correlation among the first-class object, the second-class object and the third-class object are determined at the same time.

Taking FIG. 2 as an example, the neural network obtained by training in the example may detect and determine the correlation among the human hand object, the human body object and the human face object from FIG. 2 at the same time. For example, it may be determined at the same time that: the first-class objects, i.e., the human hands H1 and H2, the second-class object, i.e., the human body B1 and the third-class object, i.e., a human face F1 have a correct correlation; the first-class object, i.e., the human hand H3, the second-class object, i.e., the human body B2 and the third-class object, i.e., a human face F2 have a correct correlation; the first-class objects, i.e., the human hands H4 and H5, the second-class object, i.e., the human body B3 and the third-class object, i.e., a human face F3 have a correct correlation.

Based on the above method concept of training a neural network in the examples of the present disclosure, as shown in FIG. 5, the present disclosure further provides a method of detecting correlated objects. As shown in FIG. 5, the method includes the following blocks.

At block 501, a first-class object and a second-class object in an image are detected.

The first-class object and the second-class object may be detected from the image to be subjected to correlated object detection at this block.

In some examples, the first-class object includes a first human body part object, and the second-class object includes a human body object; or the first-class object includes a human body object, and the second-class object includes a first human body part object. In a possible implementation, the first human body part object includes a human face object or a human hand object.

At block 502, at least one object group is generated based on the detected first-class object and the detected second-class object, where the object group includes one first-class object and at least two second-class objects.

When the first-class object and the second-class object in the image are detected, one object group may be generated based on one first-class object and at least two second-class objects at this block. Since there may be a plurality of detected first-class objects in the image, there may also be a plurality of object groups generated based on the first-class objects.

The generation of the object group based on the first-class object and the second-class object may have a plurality of implementations, which is not limited in this example. In some examples, generating at least one object group based on the detected first-class object and the detected second-class object includes: performing a combination operation for the detected first-class object; the combination operation includes: combining the first-class object and any at least two detected second-class objects into one object group; or combining the first-class object and each detected second-class object into one object group.

In the above examples, after the first-class object and the second-class object in the image are detected, a corresponding object group may be obtained by performing combination operation. For example, one corresponding object group may be obtained by combining the first-class object and any at least two detected second-class objects, or one corresponding object group may be obtained by combining the first-class object and each detected second-class object.

With FIG. 2 as an example, the first-class objects, i.e., the human hands H1, H2, H3, H4 and H5 and the second-class objects, i.e., the human bodies B1, B2 and B3 are detected in FIG. 2. In the above example, combination operation is performed for the first-class object, i.e., the human hand H5. For example, an object group Group1 (the human hand H5, the human bodies B2 and B3) may be obtained by combining the first-class object, i.e., the human hand H5 and any two, i.e., the human bodies B2 and B3 selected from the second-class objects. In an example, an object group Group2 (the human hand H5, the human bodies B1, B2 and B3) may be obtained by combining the first-class object, i.e., the human hand H5 and each detected second-class object (the human bodies B1, B2 and B3).

In some examples, generating at least one object group based on the detected first-class object and the detected second-class object includes: determining at least two second-class objects satisfying a preset relative position relationship with the first-class object as candidate correlated objects of the first-class object based on position information of the detected first-class object and the detected second-class objects; and combining the first-class object with each candidate correlated object of the first-class object into one object group.

In the above example, the relative position relationship may be preset, and at least two second-class objects satisfying the relative position relationship with the first-class object may be determined as candidate correlated objects of the first-class object based on the position information of the first-class object and the second-class objects. With FIG. 2 as an example, the relative position relationship may be preset as follows: there is an overlapping region between detection boxes of the first-class object and the second-class object. Since the detection box of the human hand H5 has an overlapping region with the detection boxes of the human bodies B2 and B3 respectively, the human bodies B2 and B3 may be taken as the candidate correlated objects of the human hand H5 in this example. Further, the human hand H5, the human bodies B2 and B3 may be combined into one candidate object group.

At block 503, the matching degree between the first-class object and each second-class object in the same object group is determined.

After the object group is generated based on the first-class object and the second-class object, the matching degree between the first-class object and each second-class object in the same object group may be determined at this block.

In some examples, determining the matching degree between the first-class object and each second-class object in the same object group includes: determining the matching degree between the first-class object and each second-class object in the same object group based on a pre-trained neural network, where the neural network is trained by the method of training a neural network according to any example of the present disclosure. Illustratively, an image to be subjected to correlated object detection may be input into the correlation detection network as shown in FIG. 3, and the neural network (the pair detection network 33) may output the matching degree between the first-class object and each second-class object in the same object group.

At block 504, the second-class object correlated with the first-class object is determined based on the matching degree between the first-class object and each second-class object in the same object group.

With FIG. 2 as an example, the same object group includes: the human hand H5, the human bodies B2 and B3. In this example, matching degrees (a matching degree m1 and a matching degree m2) between the human hand H5 and each of the human body B2 and the human body B3 may be obtained. It may be determined that the human hand H5 is correspondingly correlated with the human body B3 based on two determined matching degrees at this block. In a possible implementation, the first-class object and the second-class object having a maximum matching degree value in the same object group may be determined to have a corresponding correlation. In combination with FIG. 2, when the matching degree m2 is greater than the matching degree m1, it may be determined that the human hand H5 is correspondingly correlated with the human body B3.

In an example of the present disclosure, the first-class object and the second-class object in the image are detected, the object group may be generated based on one first-class object and at least two second-class objects, the matching degrees between the first-class object and each second-class object in the same object group are determined, and then a second-class object correlated with the first-class object is determined based on the matching degrees determined for the object group.

In the method of detecting correlated objects, a second-class object correlated with the first-class object may be determined from a plurality of second-class objects in the form of the object group. Global optimization of a plurality of matching pairs is realized in the form of the object group, and the second-class object correlated with the first-class object may be determined more accurately.

In a multi-object scenario, especially in a scenario in which blocking or overlapping is present among a plurality of objects in the image, according to the method of detecting correlated objects in the example of the present disclosure, a plurality of first-class objects and second-class objects having a correlation possibility in the image are taken in the form of the object group as detected objects of the same group. Based on the object group, global optimization of correlation detection of a plurality of matching pairs formed by the first-class objects and the second-class objects in the image is realized and the accuracy of the calculation result of the matching degree between the first-class object and the second-class object is improved.

In some examples, after the first-class object and the second-class object in the image are detected, a third-class object in the image may also be detected. The third-class object includes a second human body part object. For example, the second human body part object includes a human face object or a human hand object.

One object group is generated based on one first-class object, at least two second-class objects and at least two third-class objects which are detected in the image. Then, in the same object group, the matching degree between the first-class object and each second-class object and the matching degree between the first-class object and each third-class object are determined. A second-class object correspondingly correlated with the first-class object is determined based on the matching degree between the first-class object and each second-class object in the same object group. A third-class object correspondingly correlated with the first-class object is determined based on the matching degree between the first-class object and each third-class object in the same object group.

In the above examples, when the correlated objects are detected, the second-class object correlated with the first-class object and the third-class object correlated with the first-class object in the image may be determined at the same time. In other words, the correlation among the first-class object, the second-class object and the third-class object may be determined at the same time in the correlation detection manner without separately detecting the correlation between the first-class object and the second-class object in the image or separately detecting the correlation between the first-class object and the third-class object in the image. In a multi-object scenario, especially in the scenario in which blocking or overlapping is present among a plurality of objects in the image, the first-class object, the second-class object and the third-class object having a correlation possibility in the image are taken in the form of the object group as detected objects of the same group, and the correlation among the first-class object, the second-class object and the third-class object in the image are determined at the same time based on the object group.

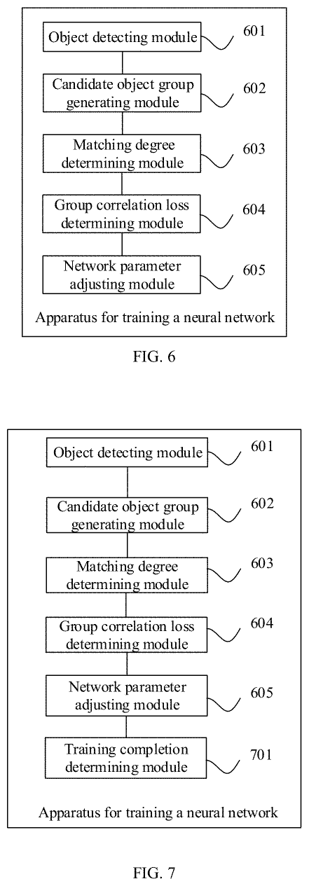

As shown in FIG. 6, the present disclosure provides an apparatus for training a neural network, and the apparatus may perform the method of training a neural network according to any example of the present disclosure. The apparatus may include an object detecting module 601, a candidate object group generating module 602, a matching degree determining module 603, a group correlation loss determining module 604 and a network parameter adjusting module 605.

The object detecting module 601 is configured to detect a first-class object and a second-class object in an image.

The candidate object group generating module 602 is configured to generate at least one candidate object group based on the detected first-class object and the detected second-class object. The candidate object group includes at least one first-class object and at least two second-class objects.

The matching degree determining module 603 is configured to determine a matching degree between the first-class object and each second-class object in the same candidate object group based on a neural network.

The group correlation loss determining module 604 is configured to determine a group correlation loss of the candidate object group based on the matching degree between the first-class object and each second-class object in the same candidate object group. The group correlation loss is positively correlated with the matching degree between the first-class object and a second-class object non-correlated with the first-class object.

The network parameter adjusting module 605 is configured to adjust network parameters of the neural network based on the group correlation loss.

In some examples, the group correlation loss is also negatively correlated with a matching degree between the first-class object and a second-class object correlated with the first-class object in the candidate object group.

In some examples, as shown in FIG. 7, the apparatus further includes: a training completion determining module 701, configured to determine that training of the neural network is completed when the group correlation loss is less than a preset loss value.

In some examples, detecting, by the object detecting module 601, the first-class object and the second-class object in the image includes: extracting a feature map of the image; and determining the first-class object and the second-class object in the image based on the feature map; determining, by the matching degree determining module 603, the matching degree between the first-class object and each second-class object in the same candidate object group based on the neural network includes: determining a first feature of the first-class object based on the feature map; obtaining a second feature set corresponding to the first feature by determining a second feature of each second-class object in the candidate object group based on the feature map; obtaining an assemble feature set by assembling each second feature in the second feature set with the first feature respectively; and determining a matching degree between the second-class object and the first-class object corresponding to an assemble feature in the assemble feature set based on the neural network.

In some examples, each second-class object and the first-class object in the candidate object group satisfy a preset relative position relationship; or there is an overlapping region between a detection box of each second-class object in the candidate object group and a detection box of the first-class object in the candidate object group.

In some examples, the first-class object includes a first human body part object, and the second-class object includes a human body object; or the first-class object includes a human body object, and the second-class object includes a first human body part object.

In some examples, the first human body part object includes a human face object or a human hand object.

In some examples, the object detecting module 601 is further configured to detect a third-class object in the image; generating, by the candidate object group generating module 602, at least one candidate object group based on the detected first-class object and the detected second-class object includes: generating at least one candidate object group based on the detected first-class object, the detected second-class object and the detected third-class object, where each candidate object group further includes at least two third-class objects; the matching degree determining module 603 is further configured to determine a matching degree between the first-class object and each third-class object in the same candidate object group based on the neural network; the group correlation loss is positively correlated with a matching degree between the first-class object and a third-class object non-correlated with the first-class object.

In some examples, the third-class object includes a second human body part object.

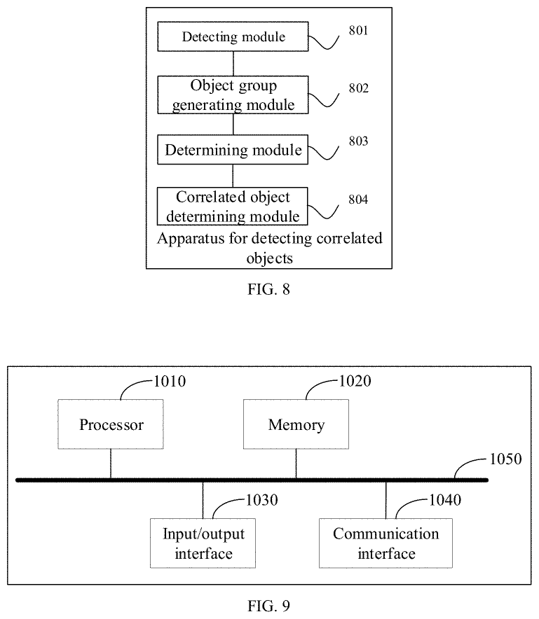

As shown in FIG. 8, the present disclosure provides an apparatus for detecting correlated objects, and the apparatus may perform the method of detecting correlated objects according to any example of the present disclosure. The apparatus may include a detecting module 801, an object group generating module 802, a determining module 803 and a correlated object determining module 804.

The detecting module 801 is configured to detect a first-class object and a second-class object in an image.

The object group generating module 802 is configured to generate at least one object group based on the detected first-class object and the detected second-class object. The object group includes one first-class object and at least two second-class objects.

The determining module 803 is configured to determine a matching degree between the first-class object and each second-class object in the same object group.

The correlated object determining module 804 is configured to determine a second-class object correlated with the first-class object based on the matching degree between the first-class object and each second-class object in the same object group.

In some examples, generating, by the object group generating module 802, at least one object group based on the detected first-class object and the detected second-class object includes: performing a combination operation for the detected first-class object; the combination operation includes: combining the first-class object and any at least two detected second-class objects into one object group; or combining the first-class object and each detected second-class object into one object group.

In some examples, generating, by the object group generating module 802, at least one object group based on the detected first-class object and the detected second-class object includes: determining at least two second-class objects satisfying a preset relative position relationship with the first-class object as candidate correlated objects of the first-class object based on position information of the detected first-class object and the detected second-class object; and combining the first-class object and each candidate correlated object of the first-class object into one object group.

In some examples, the first-class object includes a first human body part object, and the second-class object includes a human body object; or the first-class object includes a human body object, and the second-class object includes a first human body part object.

In some examples, the first human body part object includes a human face object or a human hand object.

In some examples, the detecting module 801 is further configured to detect a third-class object in the image; generating, by the object group generating module 802, at least one object group based on the detected first-class object and the detected second-class object includes: generating at least one object group based on the detected first-class object, the detected second-class object and the detected third-class object, where the object group further includes at least two third-class objects; the determining module 803 is further configured to determine a matching degree between the first-class object and each third-class object in the same object group; the correlated object determining module 804 is further configured to determine a third-class object correlated with the first-class object based on the matching degree between the first-class object and each third-class object in the same object group.

In some examples, the third-class object includes a second human body part object.

In some examples, determining, by the determining module 803, the matching degree between the first-class object and each second-class object in the same object group includes: determining the matching degree between the first-class object and each second-class object in the same object group based on a pre-trained neural network, where the neutral network is trained by the method of training a neural network according to any example of the present disclosure.

Since the apparatus examples substantially correspond to the method examples, a reference may be made to part of the descriptions of the method examples for the related part. The apparatus examples described above are merely illustrative, where the units described as separate members may be or not be physically separated, and the members displayed as units may be or not be physical units, e.g., may be located in one place, or may be distributed to a plurality of network units. Part or all of the modules may be selected according to actual requirements to implement the objectives of at least one solution in the examples. Those of ordinary skill in the art may understand and carry out them without creative work.

The present disclosure further provides a computer device, including a memory, a processor and computer programs that are stored on the memory and operable on the processor. The programs, when executed by the processor, can implement the method of training a neural network in any example of the present disclosure or the method of detecting correlated objects in any example of the present disclosure.

FIG. 9 is a schematic diagram illustrating a more specific hardware structure of a computer device according to an example of the present disclosure. The device may include: a processor 1010, a memory 1020, an input/output interface 1030, a communication interface 1040 and a bus 1050. The processor 1010, the memory 1020, the input/output interface 1030 and the communication interface 1040 communicate with each other through the bus 1050 in the device.

The processor 1010 may be implemented as a general central processing unit (CPU), a microprocessor, an application specific integrated circuit (ASIC) or one or more integrated circuits, and the like, and is configured to execute relevant programs, so as to implement the technical solution according to an example of the present disclosure.

The memory 1020 may be implemented as a read only memory (ROM), a random access memory (RAM), a static storage device, a dynamic storage device, and the like. The memory 1020 may store an operating system and other application programs. When the technical solution according to an example of the present disclosure is implemented by software or firmware, relevant program codes are stored in the memory 1020, and invoked and executed by the processor 1010.

The input/output interface 1030 is configured to connect an inputting/outputting module so as to realize information input/output. The inputting/outputting module (not shown) may be configured as a component in the device, or may also be externally connected to the device to provide corresponding functions. The input device may include a keyboard, a mouse, a touch screen, a microphone, various sensors, and the like, and the output device may include a display, a speaker, a vibrator, an indicator light, and the like.

The communication interface 1040 is configured to connect a communicating module (not shown) so as to realize communication interaction between the device and other devices. The communicating module may realize communication in a wired manner (e.g., a USB and a network cable), or in a wireless manner (e.g., a mobile network, WIFI and Bluetooth).

The bus 1050 includes a passage for transmitting information between different components (e.g., the processor 1010, the memory 1020, the input/output interface 1030 and the communication interface 1040) of the device.

It is to be noted that although the above device only includes the processor 1010, the memory 1020, the input/output interface 1030, the communication interface 1040 and the bus 1050, the device may further include other components necessary for normal operation in a specific implementation process. In addition, those skilled in the art may understand that the above device may also only include components necessary for implementation of the solution of an example of the present specification without including all components shown in the drawings.

The present disclosure further provides a non-transitory computer readable storage medium storing computer programs thereon. The programs, when executed by the processor, can implement the method of training a neural network in any example of the present disclosure or the method of detecting correlated objects in any example of the present disclosure.

The non-transitory computer readable storage medium may be a ROM, an RAM, a CD-ROM, a magnetic tape, a floppy disk, and an optical data storage device, and the like, which is not limited in the present disclosure.

In some examples, an example of the present disclosure provides a computer program product including computer readable codes. When the computer readable codes are operated on the device, the processor in the device performs the method of training a neural network in any example of the present disclosure or the method of detecting correlated objects in any example of the present disclosure. The computer program product may be implemented by hardware, software or a combination of hardware and software.

Other examples of the present disclosure will be readily apparent to those skilled in the art after considering the specification and practicing the contents disclosed herein. The present disclosure is intended to cover any variations, uses, or adaptations of the present disclosure, which follow the general principle of the present disclosure and include common knowledge or conventional technical means in the art that are not disclosed in the present disclosure. The specification and examples are to be regarded as illustrative only. The true scope and spirit of the present disclosure are pointed out by the following claims.

It is to be understood that the present disclosure is not limited to the precise structures that have described above and shown in the drawings, and various modifications and changes may be made without departing from the scope thereof. The scope of the present disclosure is only limited by the appended claims.

The above descriptions are only examples of the present disclosure but not intended to limit the present disclosure, and any modifications, equivalent substitutions, improvements, and the like made within the spirit and principles of the present disclosure shall be encompassed in the scope of protection of the present disclosure.

1. A method of training a neural network, comprising:
detecting a first-class object and second-class objects in an image;
generating at least one candidate object group based on the detected first-class object and the detected second-class objects, wherein each of the at least one candidate object group comprises at least one first-class object and at least two second-class objects;
for each of the at least one candidate object group,
determining a matching degree between the first-class object and each second-class object in the candidate object group based on a neural network;
determining a group correlation loss of the candidate object group based on the matching degree between the first-class object and each second-class object in the candidate object group, wherein the group correlation loss is positively correlated with the matching degree between the first-class object and one of the at least two second-class objects that is non-correlated with the first-class object in the candidate object group; and
adjusting network parameters of the neural network based on the group correlation loss.

2. The method according to claim 1, wherein the group correlation loss is further negatively correlated with a matching degree between the first-class object and another one of the at least two second-class objects that is correlated with the first-class object in the candidate object group.

3. The method according to claim 1, further comprising:
determining that training of the neural network is completed in response to determining that the group correlation loss is less than a preset loss value.

4. The method according to claim 1, wherein detecting the first-class object and the second-class objects in the image comprises:
extracting a feature map of the image; and
determining the first-class object and the second-class objects in the image based on the feature map,
wherein determining the matching degree between the first-class object and each second-class object in the candidate object group based on the neural network comprises:
determining a first feature of the first-class object based on the feature map;
obtaining a second feature set corresponding to the first feature by determining a second feature of each second-class object in the candidate object group based on the feature map;
obtaining an assemble feature set by assembling each second feature in the second feature set with the first feature respectively; and
determining the matching degree between the second-class object and the first-class object corresponding to an assemble feature in the assemble feature set based on the neural network.

5. The method according to claim 1, wherein:
each second-class object and the first-class object in the candidate object group satisfy a preset relative position relationship; or
there is an overlapping region between a detection box of each second-class object in the candidate object group and a detection box of the first-class object in the candidate object group.

6. The method according to claim 1, wherein:
the first-class object comprises a first human body part object, and at least one of the second-class objects comprises a human body object; or
the first-class object comprises a human body object, and the at least one of the second-class objects comprises a first human body part object.

7. The method according to claim 6, wherein the first human body part object comprises a human face object or a human hand object.

8. The method according to claim 1, further comprising:
detecting third-class objects in the image;
wherein generating the at least one candidate object group based on the detected first-class object and the detected second-class objects comprises:
generating the at least one candidate object group based on the detected first-class object, the detected second-class objects and the detected third-class objects, wherein each of the at least one candidate object group further comprises at least two third-class objects; and
wherein the method further comprises:
for each of the at least one candidate object group, determining a matching degree between the first-class object and each third-class object in the candidate object group based on the neural network, the group correlation loss being further positively correlated with the matching degree between the first-class object and one of the at least two third-class objects that is non-correlated with the first-class object in the candidate object group.

9. The method according to claim 8, wherein one of the third-class objects comprises a second human body part object.

10. A method of detecting correlated objects, comprising:
detecting a first-class object and second-class objects in an image;
generating at least one object group based on the detected first-class object and the detected second-class objects, wherein each of the at least one object group comprises one first-class object and at least two second-class objects;
for each of the at least one object group,
determining a matching degree between the first-class object and each second-class object in the object group; and
determining a second-class object correlated with the first-class object based on the matching degree between the first-class object and each second-class object in the object group.

11. The method according to claim 10, wherein generating the at least one object group based on the detected first-class object and the detected second-class objects comprises:
performing a combination operation for the detected first-class object, and
wherein performing the combination operation comprises:
combining the first-class object and a group of at least two second-class objects into one of the at least one object group; or
combining the first-class object and each second-class object into one of the at least one object group.

12. The method according to claim 10, wherein generating the at least one object group based on the detected first-class object and the detected second-class objects comprises:
determining at least two second-class objects satisfying a preset relative position relationship with the first-class object as candidate correlated objects of the first-class object based on position information of the detected first-class object and the detected second-class objects; and
combining the first-class object and each candidate correlated object of the first-class object into one of the at least one object group.

13. The method according to claim 10, wherein the first-class object comprises a first human body part object, and at least one of the second-class objects comprises a human body object, or the first-class object comprises a human body object, and the at least one of the second-class objects comprises a first human body part object.

14. The method according to claim 13, wherein the first human body part object comprises a human face object or a human hand object.

15. The method according to claim 10, further comprising:
detecting third-class objects in the image,
wherein generating at least one object group based on the detected first-class object and the detected second-class objects comprises:
generating at least one object group based on the detected first-class object, the detected second-class objects and the detected third-class objects, wherein each of the at least one object group further comprises at least two third-class objects;
wherein the method further comprises:
for each of the at least one object group, determining a matching degree between the first-class object and each third-class object in the object group, and determining a third-class object correlated with the first-class object based on the matching degree between the first-class object and each third-class object in the object group.

16. The method according to claim 15, wherein one of the third-class objects comprises a second human body part object.

17. The method according to claim 10, wherein determining the matching degree between the first-class object and each second-class object in the object group comprises:
determining the matching degree between the first-class object and each second-class object of the object group based on a pre-trained neural network.

18. The method according to claim 17, wherein the neutral network is trained by
detecting a training first-class object and training second-class objects in a training image;
generating at least one candidate object group based on the detected training first-class object and the detected training second-class objects, wherein each of the at least one candidate object group comprises at least one training first-class object and at least two training second-class objects;
for each of the at least one candidate object group,
determining a training matching degree between the training first-class object and each training second-class object in the candidate object group based on the neural network;
determining a training group correlation loss of the candidate object group based on the training matching degree between the first-class object and each second-class object in the candidate object group, wherein the training group correlation loss is positively correlated with the training matching degree between the training first-class object and one of the at least two training second-class objects that is non-correlated with the training first-class object in the candidate object group; and
adjusting network parameters of the neural network based on the training group correlation loss.

19. An apparatus comprising:
at least one processor; and
one or more memories coupled to the at least one processor and storing programming instructions for execution by the at least one processor to:
detect a first-class object and second-class objects in an image;
generate at least one candidate object group based on the detected first-class object and the detected second-class objects, wherein each of the at least one candidate object group comprises at least one first-class object and at least two second-class objects;
for each of the one candidate object group,
determine a matching degree between the first-class object and each second-class object in the candidate object group based on a neural network;
determine a group correlation loss of the candidate object group based on the matching degree between the first-class object and each second-class object in the candidate object group, wherein the group correlation loss is positively correlated with the matching degree between the first-class object and one of the at least one second-class objects that is non-correlated with the first-class object; and
adjust network parameters of the neural network based on the group correlation loss.

20. An apparatus comprising:
at least one processor; and
one or more memories coupled to the at least one processor and storing programming instructions for execution by the at least one processor to implement the method according to claim 10.
